(19) United States
(12) Patent Application Publication
(10) Pub. No.: US 2002/0116333 A1
(43) Pub. Date: Aug. 22, 2002

(54) Method of authenticating a payment account user

(76) Inventors: Joseph A. McDonnell, Weston, FL (US); Mark E. Crowson, Phenix City, AL (US); Edward R. Weintraub, Pembrok Pines, FL (US); Alessandro Warth, Miami, FL (US)

Correspondence Address: BIRCH STEWART KOLASCH & BIRCH, PO BOX 747, FALLS CHURCH, VA, 22040-0747, US

(21) Appl. No.: 09/785,217

(22) Filed: Feb. 20, 2001

(51) Int. Cl. G06F 17/60

(52) U.S. Cl. 705/40; 705/39

(57) ABSTRACT

In the method of authenticating a payment account user, payment account information indicating the payment account of a user and a purchase amount is received. Then a first authentication scheme is performed to authenticate the user as a valid user of the payment account if the purchase amount is below a predetermined threshold. Or, a second authentication scheme is performed to authenticate the user as a valid user of the payment account if the purchase amount is above the predetermined threshold.

### BACKGROUND OF THE INVENTION

In 2000, e-merchants lost more than $300 million to consumer related on-line fraud and it is estimated to reach more than $1 billion by 2002. Because of the nature of online transactions, particularly those known as “card not present” transactions, the e-merchant has drastically limited recourse against fraud. If a consumer asserts that they did not make an online purchase, the transaction is immediately charged back to the merchant.

Consequently a demand exists in the industry for methods of authenticating credit card users as the valid owner/user of the credit card. Various methods have been proposed. The methods range from very stringent tests requiring time consuming data entry requests, database look-ups, and comparisons to simple tests that would only stop less seasoned criminals. Naturally, the more stringent methods are more costly to the e-merchant, but provide the greatest amount of protection. However, some transactions have such little risk that the e-merchant would prefer not to absorb the high cost associated with the more stringent tests.

### SUMMARY OF THE INVENTION

The present invention provides a methodology for authenticating a payment account (e.g., credit card) user that selectively applies a more stringent or less stringent authentication method to a transaction based on the risk to the merchant; namely, based on the merchant's monetary exposure. In this manner, the less costly, less stringent authentication scheme can be applied to low risk transactions, and the more costly and stringent authentication scheme can be applied to the high risk transactions. The merchant obtains the best of both worlds—protection against fraud at an affordable price.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a system employing the method according to one embodiment of the present invention.

### DETAILED DESCRIPTION OF THE PREFFERED EMBODIMENTS

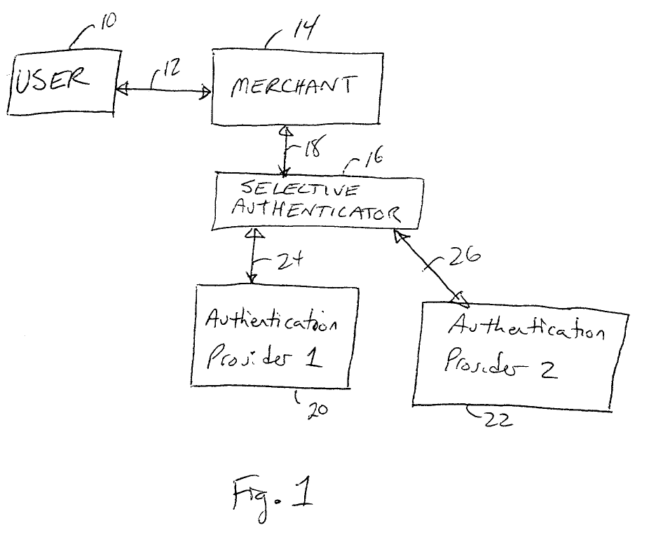

FIG. 1 illustrates a system employing the method according to one embodiment of the present invention. As shown, a user 10 communicates over a first communication medium 12 with a merchant 14. In a preferred embodiment, the user 10 represents a computer of a user, the merchant 14 represents a computer of the merchant, and the first communication medium 12 is the internet. The merchant 14 communicates with a selective authenticator 16 over a second communication medium 18. In the preferred embodiment, the selective authenticator 16 represents a computer performing the method according to the present invention, and the second communication medium 18 is the internet. The selective authenticator 16 communicates with first and second authentication providers 20 and 22 over third and fourth communication media 24 and 26, respectively. In the preferred embodiment, the first and second authentication providers 20 and 22 represent computers performing first and second authentication schemes, and the third and fourth communication media 24 and 26 are the internet.

Furthermore, the second authentication provider 22 performs an authentication scheme that is more robust or stringent than the authentication scheme performed by the first authentication provider 20. Stated another way, it is more difficult for a criminal to commit fraud when the authentication scheme of the second authentication provider 22 is performed. However, the second authentication provider 22 generally charges more for their service than the first authentication provider 20.

Next, the method according to an embodiment of the present invention will be described with reference to FIG. 1. When the user 10 makes a purchase from the merchant 14, the user 10 supplies the merchant 14 with purchase information, bill-to and/or ship-to information, personal information and payment information. The purchase information includes identifying the item or items to be purchased. From the purchase information, the merchant 14 determines the total amount of the purchase—the purchase amount. The bill-to and/or ship-to information includes billing address information and/or ship-to address information, etc. The personal information can include the user's name, address, etc. Furthermore, the merchant 14 requests any personal information needed to perform authentication (e.g., all or part of a social security number, mother's maiden name, etc.) according to either or both of the authentication schemes of the first and second authentication providers 20 and 22. The payment information includes the credit card information or other payment account information that the merchant 14 needs to debit the user's account.

Upon receipt of the above referenced information, the merchant 14 communicates with the selective authenticator 16 and supplies the bill-to and/or ship-to information, the personal information and the payment information needed to perform authentication and the purchase amount to the selective authenticator 16. In an alternative embodiment, the merchant 14 does not request the personal information needed to perform authentication. Instead, once the user 10 attempts to make a purchase, the merchant 14 connects the user 10 with the selective authenticator 16, and the selective authenticator 16 requests the personal information needed to authenticate the user 10.

The selective authenticator 16 compares the purchase amount to a predetermined threshold amount. If the purchase amount is less than or equal to the predetermined threshold amount, the selective authenticator 16 sends the bill-to and/or ship-to information, the personal information and the payment information to the first authentication provider 20 with a request to authenticate the user 10. The first authentication provider 20 then performs the first authentication scheme to authenticate the user 10, and sends the result to the selective authenticator 16. If the first authentication provider 20 authenticates the user 10, then the selective authenticator 16 forwards this result to the merchant 14 and the purchase is completed. If the first authentication provider 20 does not authenticate the user 10, then the selective authenticator 16 sends this result to the merchant 14 and the merchant 14 prevents the purchase from being completed at this time.

If, when the selective authenticator 16 compares the purchase amount to the predetermined threshold amount, the purchase amount is greater than the predetermined threshold amount, the selective authenticator 16 sends the bill-to and/or ship-to information, the personal information and the payment information to the second authentication provider 22 with a request to authenticate the user 10. The second authentication provider 22 then performs the second authentication scheme to authenticate the user 10, and sends the result to the selective authenticator 16. If the second authentication provider 22 authenticates the user 10, then the selective authenticator 16 forwards this result to the merchant 14 and the purchase is completed. If the second authentication provider 22 does not authenticate the user 10, then the selective authenticator 16 sends this result to the merchant 14 and the merchant 14 prevents the purchase from being completed at this time.

In this manner, by setting the predetermined threshold amount as desired by the merchant 14, the merchant 14 can realize the greatest authentication benefit for the amount of risk the merchant 14 is willing to take. As a result, the merchant 14 subjectively receives the optimal cost for authentication services.

Additionally, the selective authenticator 16 provides a guarantee when reporting to the merchant 14 that the user 10 has been authenticated. Later, if the transaction turns out to be fraudulent, e.g., due to an unauthorized usage of an individuals' payment and or personal information; or from the actual authorized user later denying the transaction., etc., the merchant 14 can exercise the guarantee and receive compensation from the selective authenticator 16 for the purchase amount lost due to fraud. In this manner, the merchant 14 will feel confident in using the services of the selective authenticator 16.

In an alternative embodiment, the first or second authentication provider 20 and 22 is connected with the user 10 by the selective authenticator 16, and the first or second authentication provider 20 and 22 requests the personal information needed to perform authentication from the user 10.

In a further alternative embodiment, the purchase amount is initially compared to a second predetermined threshold amount, which is less than the first predetermined threshold amount discussed above. And, if the purchase amount is less than the second predetermined threshold amount, the user 10 is authenticated without having any authentication scheme performed.

In still further alternative embodiments, the selective authenticator 16 selects from more than two authentication schemes providing differing degrees of protection based on more than just one predetermined threshold amount.

The invention being thus described, it will be obvious that the same may be varied in many ways. For instance, the invention should not be limited to particular authentication schemes. However, examples of the first and second authentication schemes are those authentication schemes provided by Experian and Equifax, respectively. Such variations are not to be regarded as a departure from the spirit and scope of the invention, and all such modifications are intended to be included within the scope of the following claims.

What is claimed is:

1. A method of authenticating a payment account user, comprising:
receiving at least payment account information of a user and a purchase amount to debit from a payment account indicated in the payment account information;
causing the performance of a first user authentication scheme to authenticate the user as a valid user of the payment account if the purchase amount is below a predetermined threshold; and
causing the performance of a second user authentication scheme to authenticate the user as a valid user of the payment account if the purchase amount is above the predetermined threshold.

2. The method of claim 1, wherein the second user authentication scheme is a stronger authentication scheme than the first user authentication scheme.

3. The method of claim 1, further comprising:
preventing a purchase if the first or second user authentication scheme fails to authenticate the user.

4. The method of claim 1, further comprising:
performing no authentication scheme if the purchase amount is less than a second predetermined threshold, the second predetermined threshold being less than the first predetermined threshold.

5. The method of claim 1, further comprising:
providing a guarantee if the first or second authentication scheme authenticates the user.

6. The method of claim 5, wherein the guarantee is provided to a merchant to protect against a situation in which a transaction associated with an authenticated payment account user is charged back to the merchant or disputed as being fraudulent.

7. The method of claim 1, wherein the payment account is a credit account.

8. The method of claim 7, wherein the credit account is a credit card, debit card, prefunded card or other similar type account.
